(19) United States
(12) Patent Application Publication
(10) Pub. No.: US 2003/0051194 A1
(43) Pub. Date: Mar. 13, 2003

(54) Portable SCSI bus analyzer

(75) Inventors: Rafael Graniello Cabezas, Austin, TX (US); Jason Eric Moore, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/951,948

(22) Filed: Sep. 13, 2001

(51) Int. Cl. G06F 11/273

(52) U.S. Cl. 714/43

(57) ABSTRACT

The present invention provides a portable SCSI bus analyzer (PSBA) that is less bulky and less expensive than the known prior art systems. The PSBA provides a portable device that may be connected to a SCSI port of a computing system and may act as a target or initiator on the SCSI bus. The PSBA gathers trace data of data transactions occurring over the SCSI bus and stores them either in a storage device of the computing system or, in a preferred embodiment, on a removable memory card inserted into a memory card interface of the PSBA. The PSBA gathers the trace data for a predetermined period of time. At the end of the trace, or test, the PSBA may be removed from the computing system and transported to another location where an analysis device is provided with the trace data. The analysis device analyzes the trace data in order to determine potential sources of error in the operation of the computing system.

### BACKGROUND OF THE INVENTION

1. Technical Field

The present invention is directed to an improved computing device. More specifically, the present invention is directed to a portable SCSI bus analyzer.

2. Description of Related Art

The Small Computer System Interface (SCSI) (pronounced “scuzzy”) is a hardware interface that allows for the connection of multiple peripheral devices to a single board, called a SCSI host adapter, that plugs into the motherboard of a computer, typically using a PCI slot. Internal SCSI peripheral devices, e.g., hard drives, CD-ROMS, etc., only have one SCSI connector used to connect to the next SCSI peripheral device to thereby allow SCSI devices to be daisy chained together. External SCSI device will have two connectors to facilitate chaining of devices together. SCSI host adapters are also available with two controllers that support up to 30 peripherals.

A SCSI bus is a common pathway between a plurality of SCSI devices through which data and control signals may pass between the SCSI devices. Often, it is necessary to analyze the performance of a SCSI bus to determine the source of error in the performance of the SCSI devices connected to it, or in the SCSI bus itself.

In the present technology, in order to perform SCSI bus analysis, bulky and expensive hardware is required for both obtaining SCSI bus trace data and analyzing the SCSI bus trace data. That is, SCSI bus trace data acquisition and analysis is performed by the same piece of expensive hardware.

One such known system, the Ultra320 SCSI Analyzer available from Verisys (see www.verisys.com), is a small pod that attaches to the PCMCIA slot of a laptop or personal computer. The Ultra320 is a combination data gatherer and analyzer that cannot operate independently of the personal computer.

Other such known systems include the Ultra2160 SCSI Bus Analyzer, Ultra2080 and Ultra200/Lite SCSI Bus Analyzers available from Ancot Corporation (see www.ancot.com). These systems are essentially a personal computer in a briefcase integrated with an analyzer.

All of these known systems suffer from the disadvantage that they are expensive and bulky machinery. Thus, it would be beneficial to have a portable and relatively low cost solution to SCSI bus analysis.

### SUMMARY OF THE INVENTION

The present invention provides a portable SCSI bus analyzer (PSBA) that is less bulky and less expensive than the known prior art systems. The PSBA provides a portable device that may be connected to a SCSI port of a computing system and acts as either an initiator, a target, or is transparent. If the bus is completely populated with devices, the PSBA operates in transparent mode and is limited to gathering information and will not be able to communicate with the system or any other devices on the bus. target or an initiator on the SCSI bus. The PSBA gathers trace data of data transactions occuring over the SCSI bus and stores them either in a storage device of the computing system or, in a preferred embodiment, on a removable memory card inserted into a memory card interface of the PSBA. The PSBA gathers the trace data for a predetermined period of time.

At the end of the trace, or test, the PSBA may be removed from the computing system and transported to another location where an analysis device is provided with the trace data. The analysis device analyzes the trace data in order to determine potential sources of error in the operation of the computing system.

In an alternative embodiment, rather than removing the entire PSBA from the computing system, only the memory card is removed and transported to the analysis device. The memory card is then inserted into an appropriate memory card interface of the analysis device which may then read the trace data from the memory card.

In another embodiment of the present invention, if the computing system is connected to a network, the PSBA may use the network connection of the computing system to transmit the trace data to a remotely located analysis device which performs the analysis on the trace data. In a related embodiment, rather than having a separate device perform the analysis, the computing system under test may be equipped with the analysis algorithms for analyzing SCSI bus trace data. Thus, the SCSI bus trace data in the memory card of the PSBA or in a storage device of the computing system may be analyzed by the computing system itself. These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram of a computing device with which the present invention may be used;

FIG. 2 is an exemplary block diagram of a computing device to which the portable SCSI bus analyzer of the present invention is coupled;

FIG. 3 is an exemplary block diagram of the portable SCSI bus analyzer according to the present invention;

FIG. 4A is top view of the portable SCSI bus analyzer of the present invention;

FIG. 4B is a left side view of the portable SCSI bus analyzer of the present invention;

FIG. 4C is a right side view of the portable SCSI bus analyzer of the present invention;

FIG. 5 is a high level flowchart outlining the operation of the present invention; and

FIG. 6 is an exemplary diagram of a distributed data processing system in which the present invention may operate.

### DETAILED DESCRIPTION OF THE PREFERRED EMBODIMENTS

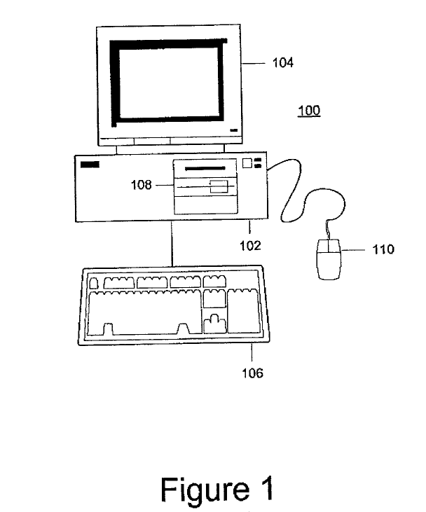

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

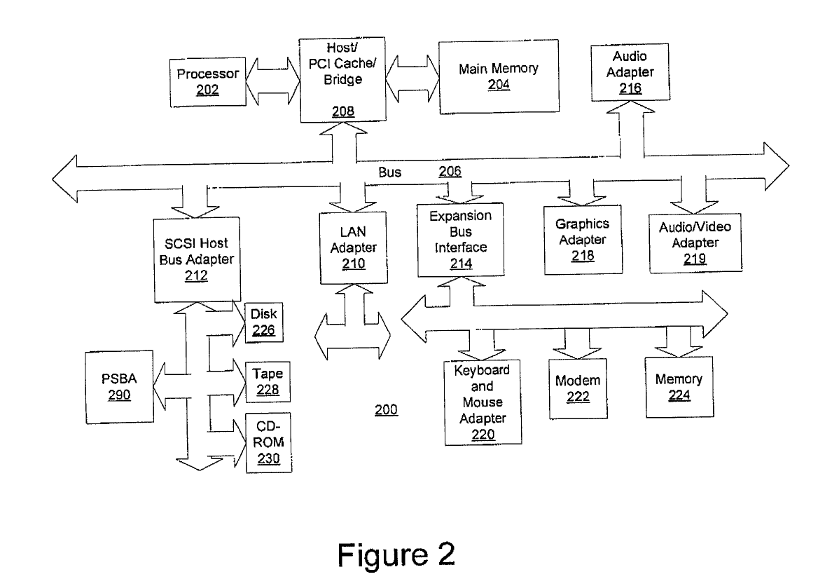

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface (SCSI) host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230, as noted by dotted line 232 in FIG. 2 denoting optional inclusion. In that case, the computer, to be properly called a client computer, must include some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

In addition to the elements described above, the data processing system 200 also has a portable SCSI bus analyzer 290 coupled to the SCSI bus 296. The portable SCSI bus analyzer 290 snoops the data transfers across the SCSI bus 296 and records the data transfer information as trace data in a storage device. The portable SCSI bus analyzer 290 can be a passive device coupled to the SCSI bus 296 such that the portable SCSI bus analyzer 290 only records the data transfers that are occurring across the SCSI bus 296. In addition, the portable SCSI bus analyzer (PSBA) 290 may perform tests on the SCSI bus 296. For example, the PSBA 290 can send various data patterns and data sequences across the bus to help determine the nature of any problems. The PSBA may also inject error conditions and illegal commands on the SCSI bus to test for proper device response.

In one embodiment, the PSBA 290 stores the trace or test data on a removable medium, such as a memory card, floppy diskette, writable CD-ROM, or the like, associated with the PSBA 290. In other embodiments, the storage device is a system storage device such as memory 224, disk 226, tape 228, or the like. In still other embodiments, the storage device is a combination of both the memory card and the system storage device, as described in greater detail hereafter.

In a preferred embodiment, the trace data is stored on a removable memory card that is inserted into a memory card interface of the PSBA 290. The memory card provides a portable and convenient storage medium for the trace data that may be easily removed and transported to an analysis device for analysis of the trace data.

If the trace continues for enough time to where the storage capacity of the memory card is exceeded, an indicator may be provided to a human technician requesting that the memory card be swapped out for another memory card having more storage capacity. The indicator may take many forms including a light emitting diode (LED) on the PSBA 290, ejection of the memory card, an audible indicator, a message being output by one or more output devices of the computing system, or the like.

In an alternative embodiment, rather than storing the data on a removable memory card, the trace data may be stored in a storage device associated with the computing system under test. The PSBA 290 is provided with algorithms allowing the PSBA 290 to gather the trace data and write the trace data to one or more storage devices in the computer system under test. In this embodiment, the trace data may be stored in the storage device until transferred to an appropriate analysis device, or may be compressed and transferred to a memory card associated with the PSBA 290 after completion of the trace.

In yet another embodiment, the trace data is first written to a memory card associated with the PSBA 290 and, when the memory card capacity is exceeded, the trace data in the remaining trace data is written to a location in a storage device associated with the computing system under test. After the trace is complete, the human technician may be prompted to insert an additional memory card for transfer of the trace data from the local storage device of the computing system under test, to the additional memory card. Of course, there may be many other possible embodiments for storage of the trace data that may be used without departing from the spirit and scope of the present invention.

In any of the embodiments described above, the trace data may be encrypted in order to maintain security of the computing system under test. Any known encryption method may be used to perform the encryption of the trace data without departing from the spirit and scope of the present invention.

Once the trace, or test, is complete, the trace data is provided to an analysis device that executes analysis algorithms on the trace data to provide a picture of the operation of the SCSI bus 296 as well as diagnose potential problems with the operation of the SCSI bus 296 or the SCSI devices connected to it.

The trace data may be provided to the analysis device in any of a number of different ways. As previously mentioned, the trace data may be provided to the analysis device by physically transporting the PSBA 290 or only the memory card to the analysis device and coupling the PSBA 290 or memory card to the analysis device via an appropriate interface. The analysis device may then read the trace data, decrypt it if necessary, and perform analysis operations on the trace data in a manner generally known in the art.

In another embodiment, the trace data may be transmitted to the analysis device via a network to which the computing system under test is connected. For example, the PSBA 290 may gather trace data and, at the end of the trace, transmit this trace data to a remotely located analysis device via the modem 222 or LAN adapter 210. In yet another embodiment, the computing system under test itself may be provided with the analysis algorithms such that the computing system under test becomes the analysis device. In such an embodiment, the trace data may be read from the memory card or a local storage device by the processor 202 and analysis algorithms run on the read-in trace data.

Thus, the present invention separates out the functions of gathering trace data from a SCSI bus and analysis of the trace data. By separating out these functions, a simple, low cost, and portable device may be provided for trace data gathering while the more expensive analysis device may be maintained in a remote location from the computing systems under test. In addition, a plurality of simple trace data collection devices may be used for a number of different computing systems with a single analysis device being used to perform the actual analysis of the trace data. In this way the problems of having to transport a bulky and expensive analysis device to the location of the computing system under test are avoided.

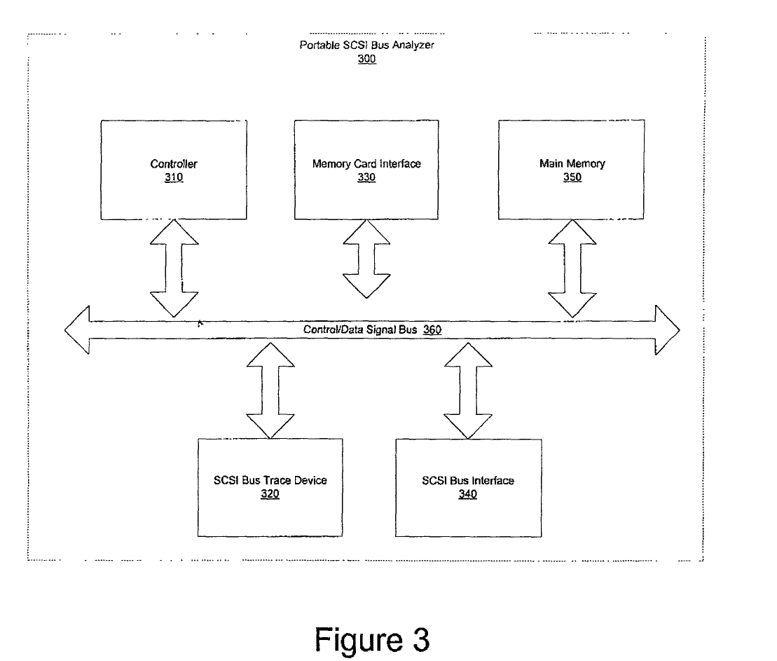

FIG. 3 is an exemplary block diagram of the PSBA according to the present invention. As shown in FIG. 3, the PSBA 300 includes a controller 310, a SCSI bus trace device 320, a memory card interface 330, a SCSI bus interface 340, and a main memory 350. The elements 310-350 are in communication with one another via the control/data signal bus 360. Although a bus architecture is shown in FIG. 3, the present invention is not limited to such and any architecture that facilitates the communication of control/data signals between the elements 310-350 may be used without departing from the spirit and scope of the present invention.

The controller 310 controls the overall operation of the PSBA 300 and orchestrates the operation of the other elements 320-350. In operation, the controller 310 operates based on control programs stored in main memory 350. In addition, the operation of the controller 310 may be modified through programming by an external computing device via the SCSI bus interface 340. That is, before the PSBA 300 is used with a computing system under test, the PSBA 300 may be first programmed by setting attributes or providing algorithms to the main memory 350. This programming may include, for example, information identifying the types of data transfers that the PSBA 300 is to record for later analysis.

In operation, after having been programmed, the PSBA 300 is coupled to a SCSI bus via a SCSI bus port on the computing system under test and SCSI bus interface 340. By coupling the PSBA 300 to the computing system under test, power is supplied to the PSBA 300 via a power line in the SCSI bus interface 340 connection. This the case for the 80 pin connectors that carry control/data and power signals. When monitoring a 68 pin environment, the PSBA must draw power from the host system or some external power source.

Upon powering on, the controller 310 begins executing trace programs stored in main memory 350. Such programs provide the controller 310 with instructions for initiating the trace of the SCSI bus data transfers using the SCSI bus trace device 320. These instructions may include an indication of the types of data transfers to identify and record using the SCSI bus trace device 320. These instructions may further include an indication of the length of time that the trace is to be performed.

When instructed to operate by the controller 310, the SCSI bus trace device 320 begins snooping the SCSI bus via the SCSI bus interface 340 and recording data transfer information on the memory card via the memory card interface 330. As previously mentioned, rather than, or in addition to storing trace data on the memory card, the present invention may store trace data in local storage on the computing system under test. In such an embodiment, the trace data may be sent to the local storage via the SCSI bus interface 340. Such data transfer may not be picked up in trace data by the SCSI bus trace device 320 because such data transfers will not be of interest as identified through the programming of the PSBA 300.

As trace data is written to the memory card via the memory card interface 330, it may occur that the memory capacity of the memory card is exceeded. In such a case, the controller 310 may instruct an indicator (not shown) to operate. This indicator may be a visible indicator such as an LED, ejection of the memory card from the memory card interface 330, a message displayed on a display screen of the computing system under test, or the like.

Alternatively, the indicator may be an audible indicator such as a sound emitted by the PSBA 300, a sound emitted by the computing system under test, and the like. In addition, the controller 310 may prompt a human technician to swap out the memory card with another memory card having additional storage capacity.

When the trace is complete, the controller 310 instructs the SCSI bus trace device 320 to end the trace. The end of the trace may be identified by the expiration of a preprogrammed period of time for the trace, the removal of the PSBA 300 from the SCSI bus, or the like. Upon termination of the trace, the controller 310 may again instruct an indicator to operate to thereby inform a human technician that the trace is complete.

The PSBA 300 may then be removed, if it has not already been removed, from the SCSI bus port and transported to an analysis device. Alternatively, rather than removing the entire PSBA 300, only the memory card may be removed from the memory card interface 330 and transported to the analysis device. In another embodiment of the present invention, upon termination of the trace, the controller 310 may instruct the computing system under test, via the SCSI bus interface 340, to transmit the trace data over a network connection to the analysis device. In any of the embodiments above, when the trace data is received by the analysis device, the analysis device performs analysis operations on the trace data in a manner generally known in the art.

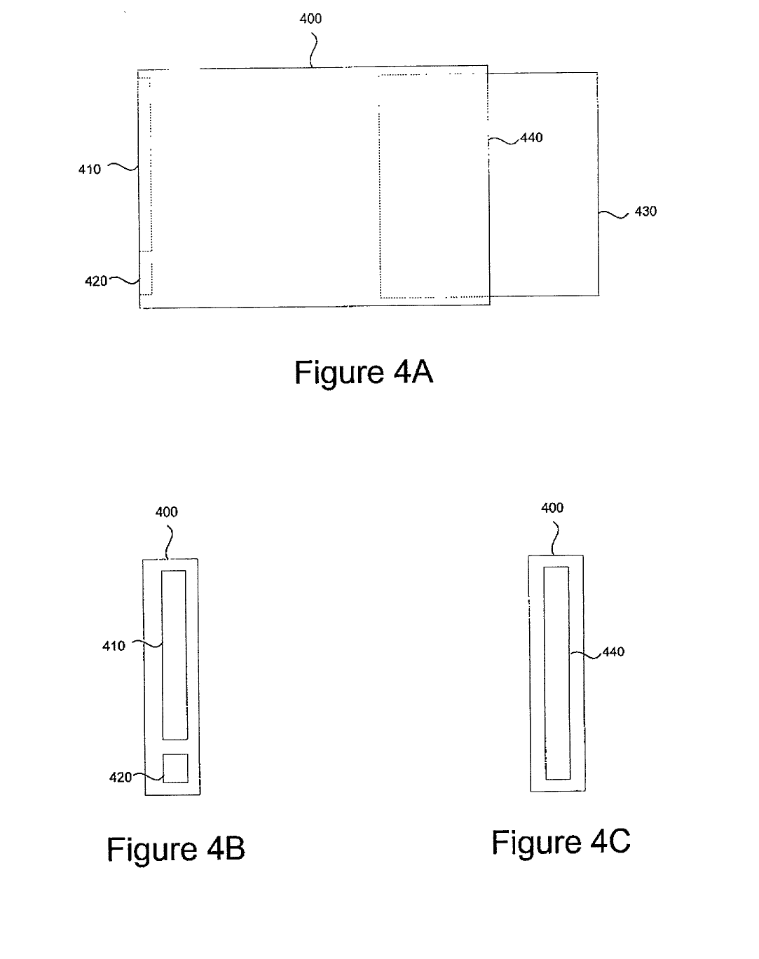

FIG. 4A is a top view of the PSBA 400 according to the present invention. As shown in FIG. 4A, the PSBA 400 includes a SCSI bus interface 410, such as a SCSI connector, and a power connector 420 at one end of the PSBA 400. The SCSI bus interface 410 may be placed in direct contact with a SCSI connector associated with a SCSI bus or may be connected to the SCSI connector of the SCSI bus by way of a data cable or the like.

On the opposite end of the PSBA 400 from the SCSI bus interface 410, a memory card interface 440 is provided. The memory card interface 440 may be, for example a physical slot in the housing of the PSBA 400 with connectors that engage counterpart connectors in the memory care 430 when the memory card 430 is inserted into the slot.

FIG. 4B is a side view of the PSBA 400 showing the side of the PSBA 400 in which the SCSI bus interface 410 and the power connector 420 are positioned. FIG. 4C is a side view of the PSBA 400 showing a side of the PSBA 400 in which the memory card interface 440 is positioned. FIGS. 4A-4C represent only one possible embodiment of the present invention and are not intended to imply any limitations in the physical layout of the PSBA 400. Many modifications may be made without departing from the spirit and scope of the present invention.

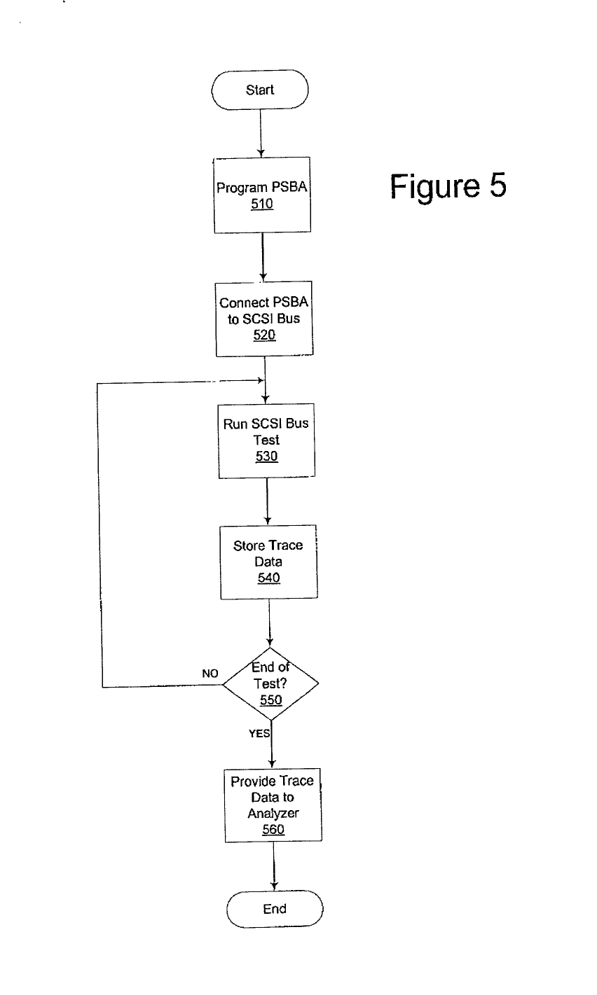

FIG. 5 is a high level flowchart outlining an exemplary operation of the present invention. As shown in FIG. 5, the operation starts with programming of the PSBA (step 510). This step may be performed by coupling the PSBA to a computing system, such as the analysis device, and performing functions to program the PSBA regarding the types of data transfers that are to be recorded by the PSBA and the length of time of the trace that is to be performed. In an alternative embodiment, the PSBA may be provided with the computing system under test, in which case the PSBA may be programmed through the computing system under test by software resident on the computing system under test.

The PSBA is then transported to the computing system under test, if it is not already provided with the computing system under test, and connected to the SCSI bus (step 520). The SCSI bus trace, or test, is then run on the SCSI bus (step 530) and the trace data stored (step 540). As mentioned previously, this may involve storing the trace data to a memory card, a local storage device of the computing system under test, or both.

A determination is made as to whether the trace or test is ended (step 550). If not, the operation returns to step 530 and continues the trace. If the trace or test has ended, the trace data is provided to the analysis device (step 560). As mentioned earlier, this may involve removing the PSBA and/or the memory card and transporting it to the analysis device. Alternatively, this may involve transmitting the trace data over a network connection of the computing system under test. In yet another embodiment, if the computing system under test is provided with the analysis software, this step may involve simply providing the trace data to the analysis programs being run by the computing system under test.

Thus, the present invention provides a portable and cost effective way to perform analysis of SCSI buses in computing systems. With the present invention, a simple portable data collection device may be transported to remotely located computing systems and used to collect trace data. These portable devices may then be used to provide the trace data to a more stationary analysis device for analysis of the operation of the SCSI bus.

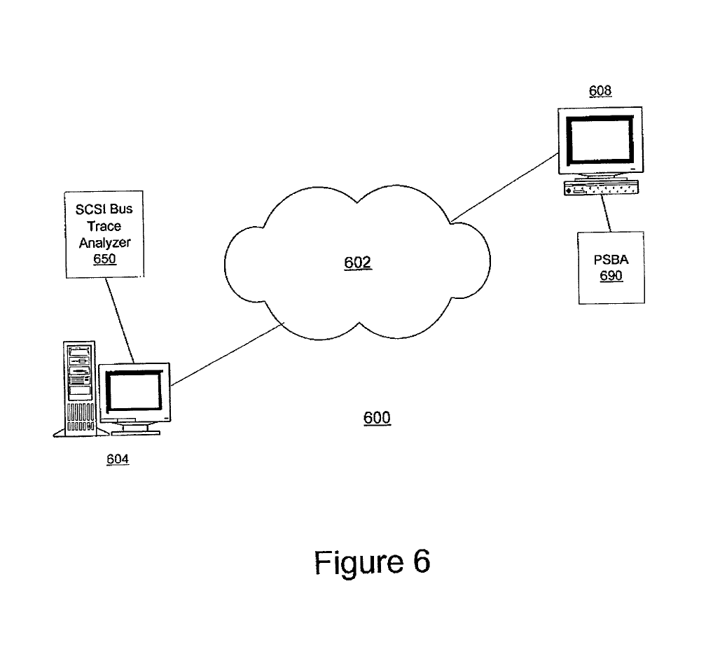

FIG. 6 is an exemplary diagram of one of the alternative embodiments of the present invention in which the computing system under test has a network connection. As shown in FIG. 6, the PSBA 690 is coupled to the computing system 608 to collect trace data for data transactions occurring over a SCSI bus in the computing system 608. The SCSI bus trace data analyzer 650 is associated with a server 604 that is connected to the computing system 608 via the network 602.

With this distributed data processing system 600, the PSBA 690 may collect trace data from the computing system 608 and then instruct the computing system 608 to transmit the trace data to the server 604. As mentioned earlier, this trace data may be encrypted in order to maintain security of the data when being transmitted over the network 602.

When the trace data is received by the server 604, it may be decrypted and provided to the SCSI bus trace data analyzer 650. The SCSI bus trace data analyzer 650 may then perform analysis operations on the trace data in order to examine the operation of the SCSI bus of the computing system 608.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of performing bus analysis, comprising:
initiating a data trace on the bus;
collecting trace data using a first device coupled to the bus;
providing the trace data to a second device different from, and external to, the first device; and
analyzing the trace data using the second device.

2. The method of claim 1, wherein collecting trace data using a first device includes storing the trace data on a removable medium associated with the first device.

3. The method of claim 1, wherein the trace data is provided to the second device by recording the trace data on a removable medium associated with the first device, and physically transporting the removable medium to the second device.

4. The method of claim 1, wherein the trace data is provided to the second device by transmitting the trace data over a network from the first device to the second device.

5. The method of claim 1, wherein initiating a data trace includes injecting at least one or data patterns, data sequences, error conditions, and illegal commands onto the bus and recording the operation of the bus.

6. The method of claim 2, wherein collecting the trace data further includes:
determining if a free capacity of the removable medium is approximately zero; and
prompting a user to insert an additional removable medium if the free capacity of the removable medium is approximately zero.

7. The method of claim 2, wherein collecting the trace data further includes:
determining if a free capacity of the removable medium is approximately zero; and
redirecting collection of the trace data to a storage medium associated with a system under test if the free capacity of the removable medium is approximately zero.

8. The method of claim 1, wherein the first device is a portable data collection device.

9. The method of claim 1, wherein the first device is located remotely from the second device.

10. The method of claim 2, wherein the removable medium is a memory card.

11. A system for performing bus analysis, comprising:
a data collection device capable of being coupled to a bus; and
an analysis device different from the data collection device, capable of performing bus trace data analysis, wherein the data collection device collects trace data from the bus, the trace data is provided to the analysis device, and the analysis device analyzes the trace data.

12. The system of claim 11, wherein the data collection device further includes a removable medium and wherein the data collection device stores the trace data on the removable medium.

13. The system of claim 11, wherein the trace data is provided to the analysis device by recording the trace data on a removable medium associated with the data collection device, and physically transporting the removable medium to the analysis device.

14. The system of claim 11, wherein the trace data is provided to the analysis device by transmitting the trace data over a network from the data collection device to the analysis device.

15. The system of claim 11, wherein the data collection device initiates a data trace of the bus by injecting at least one or data patterns, data sequences, error conditions, and illegal commands onto the bus and recording the operation of the bus.

16. The system of claim 12, wherein the data collection device determines if a free capacity of the removable medium is approximately zero, and prompts a user to insert an additional removable medium if the free capacity of the removable medium is approximately zero.

17. The system of claim 12, wherein the data collection device determines if a free capacity of the removable medium is approximately zero, and redirects collection of the trace data to a storage medium associated with a system under test if the free capacity of the removable medium is approximately zero.

18. The system of claim 11, wherein the data collection device is a portable data collection device.

19. The system of claim 11, wherein the data collection device is located remotely from the analysis device.

20. The system of claim 12, wherein the removable medium is a memory card.

21. A computer program product for performing bus analysis, comprising:
first instructions for initiating a data trace on the bus;
second instructions for collecting trace data using a first device coupled to the bus;
third instructions for providing the trace data to a second device different from, and external to, the first device; and
fourth instructions for analyzing the trace data using the second device.

22. The computer program product of claim 21, wherein the second instructions for collecting trace data using a first device include instructions for storing the trace data on a removable medium associated with the first device.

23. The computer program product of claim 21, wherein the third instructions include instructions for transmitting the trace data over a network from the first device to the second device.

24. The computer program product of claim 22, wherein the second instructions for collecting the trace data further include:
instructions for determining if a free capacity of the removable medium is approximately zero; and
instructions for prompting a user to insert an additional removable medium if the free capacity of the removable medium is approximately zero.

25. The computer program product of claim 22, wherein the second instructions for collecting the trace data further include:
instructions for determining if a free capacity of the removable medium is approximately zero; and
instructions for redirecting collection of the trace data to a storage medium associated with a system under test if the free capacity of the removable medium is approximately zero.

26. A portable apparatus for collecting bus trace data, comprising:
A controller;
A bus interface coupled to the controller; and
A removable medium interface coupled to the controller, wherein the portable apparatus is capable of being coupled to a bus interface of a system under test, and wherein the controller controls the collection of trace data via the bus interface and the storage of the trace data on a removable medium associated with the portable apparatus via the removable medium interface.

27. The portable apparatus of claim 26, wherein the bus interface is a Small Computer System Interface (SCSI) bus interface.

28. The portable apparatus of claim 26, wherein the removable medium is a memory card.

29. The portable apparatus of claim 26, further comprising an indicator for indicating a need to swap removable media.

30. The portable apparatus of claim 29, wherein the indicator is a light emitting diode.
